(19) United States
(12) Patent Application Publication
(10) Pub. No.: US 2020/0412685 A1
(43) Pub. Date: Dec. 31, 2020

(54) COMMUNICATION ASSOCIATION MODEL

(71) Applicant: ENT. SERVICES DEVELOPMENT CORPORATION LP, Houston, TX (US)

(72) Inventors: Joshua HAILPERN, Sunnyvale, CA (US); William J. ALLEN, Corvallis, OR (US)

(73) Assignee: ENT. SERVICES DEVELOPMENT CORPORATION LP, Houston, TX (US)

(21) Appl. No.: 17/015,666

(22) Filed: Sep. 9, 2020

Related U.S. Application Data
(63) Continuation of application No. 15/562,407, filed on Sep. 27, 2017, now abandoned.

(51) Int. Cl. H04L 12/58; H04L 12/24; H04L 29/08

(52) U.S. Cl. CPC H04L 51/36; H04L 51/16; H04L 67/20; H04L 51/04; H04L 41/145

(57) ABSTRACT

Example implementations relate to a communication association model. For example, a computing device may include a processor. The processor may access a first and a second communication, the second communication originating based on the first communication. The processor may analyze the first communication to obtain first data associated with the first communication and analyze the second communication to obtain the second data associated with the second communication, where the first data includes data associated with a first sender a first recipient of the first communication and the second data includes data associated with a second sender and a second recipient of the second communication. The processor may create an association between the first data and the second data and may generate a model specifying the associated based on the first data and the second data, where the model indicates an impact associated with the first communication and the second communication.

### CROSS-REFERENCE TO RELATED APPLICATIONS

This application is a continuation of U.S. application Ser. No. 15/562,407, filed on Sep. 27, 2017, which is a national stage application pursuant to 35 U.S.C. § 371 of International Application No. PCT/US2015/023138, filed Mar. 27, 2015, all of which are incorporated in their entireties herein by reference.

### BACKGROUND

Many entities utilize several independent systems for various operations. For example, a company may use a third-party email system for email services, a third-party web page system for web page services, a database management system for managing databases used by the company, and the like. Content from these disparate systems may be stored, accessed, and managed independently (e.g., by the third-party providing the service).

### BRIEF DESCRIPTION OF THE DRAWINGS

Some examples of the present application are described with respect to the following figures:

FIG. 1 is a block diagram of an example system for generating a model specifying an association between communications;

FIG. 2 is a block diagram of an example computing device for generating a model specifying an association between communications; and

FIG. 3 is a flowchart of an example method for providing a model specifying an association between communications.

### DETAILED DESCRIPTION

As described above, many entities may utilize several independent systems for various operations. For example, an entity may have employees working on projects that utilize these independent systems. Employees working on a project as a group or in a team may utilize various tools for communicating with one another, such as email, text messages, chat messages, tasks, documents, and the like. These communications may have a particular impact and/or may cause certain subsequent activities (e.g., subsequent activities carried out by a human and/or by a machine) based on the effectiveness of the communications.

A communication association model may be used to provide insight into the impact caused by propagation of various communications. A communication may be any data source that may be communicated from one user to another user, such as email, text messages, chat messages, tasks, documents, and the like. Information associated with communications may be tracked, such as where a communication has gone, who the communication has been sent from and/or forwarded to, who has accessed the communication, related attachments and/or links, and the like. The information tracked may be used to create a model showing the organizational impact associated with any communication. This may allow users to understand how their outbound communications may affect the greater organization in which they may operate and interact by automatically analyzing the context of various communications. For example, individual contributors and/or management of an organization may use the model to view, measure, and quantify organizational effects of communications over any period and/or length of time. In some examples, the model may be used to make any suitable recommendations to users, such as recommending people to contact based on an email a user is writing, recommending forwarding a particular communication to suggested people, and the like.

In some examples, a model may be generated by accessing related communications. Communications that are related may be related based on any type of channel and/or vector linking the communications (e.g., a communication that is subsequently forwarded in another communication, a communication created from a previous communication based on cutting and pasting content from the previous communication, etc.). However, related communications may be related even if they are related by different types of vectors (e.g., an email may be related to a text message). For example, an email may be received, and the recipient of the email may send an interactive chat message to a colleague on the topic. Subsequently, that colleague may draft an email to a manager to discuss the topic. The original email, the interactive chat message, and the subsequent email to the manager may be tracked and associated with each other independent of the particular vector of communication involved. For example, a first communication and a second communication may be accessed, where the second communication originates based on the first communication. The first communication may be analyzed to obtain first data associated with the first communication, where the first data includes any data associated with the first communication (e.g., the sender and/or the recipient of the first communication). The second communication may also be analyzed to obtain second data associated with the second communication, where the second data includes any data associated with the second communication (e.g., the sender and/or the recipient of the second communication). An association between the first and the second data may be created, and a model specifying the association may be generated based on the first and the second data. The association may be created in any suitable manner, such as by storing the data together, creating a cluster of the data, associating the data with a common identifier, and the like. The model may indicate an impact associated with the first and the second communication. For example, the model may indicate a temporal view of how the communication is distributed to various people, may identify where the information flows are (e.g., identify the users who forward communications frequently, users who are able to get other users to follow onto certain ideas and/or activities, etc.), and the like. In some examples, the model may be used to find actual networks of users (e.g., as opposed to lightweight directory access protocol (LDAP) company reporting infrastructure) to see how users interact and where various organizations of people are situated compared to the company organization). In some examples, privacy and/or visibility settings may be used to determine the contents of a model specifying communication associations. For example, a user viewing a model may be able to see the full names of people receiving communications related to a particular original communication or may only see vague descriptions of those people (e.g., an email was forwarded to a person in Atlanta, a text message was sent to a first-level manager, an email was opened by five people in a given business unit, etc.). In some examples, users may elect to participate or to not participate in communication tracking, and the model may reflect the associations accordingly (e.g., certain users may be specified as being anonymous).

When a communication is sent from a sender to one or more recipients, the communication and any suitable information associated with the communication may be tracked, including tracking to whom the original communication is sent, tracking the number of times someone opens a particular communication, and the like. Subsequent communications from the original sender and/or the original recipients in the context of and/or spawned from the original communication may be analyzed. A set of associated and analyzed communications that are related may be collected, and subsequent related communications may be added to the set. This set of associated and analyzed communications may be used to create a model specifying the association (e.g., a network model, a graph model, a historic model, etc.). Eventually, related communications may stop, or the context of communications may drift far enough from the original communications that the set stops growing. In some examples, the process of collecting communications for a particular set may continue indefinitely, and additional related communications may be added to the set at any time. In some examples, the process may be terminated based on any suitable specified criteria, such as after a particular amount of time has elapsed, after a period of inactivity of related communications, after a threshold number of hops exists between the subsequent communication of interest and the associated original communication, and the like. For example, when a communication is received, it may be determined whether to update the model based on the communication, and the determination may be made based on any suitable specified criteria that may be applied to the communication.

Communications may be collected and associated in any suitable manner. In some examples, communications may be filtered based on any suitable criteria, and communications may be added to a set of associated collected communications based on the criteria. In some examples, related communications may be collected without filtering or by filtering with less stringent criteria to collect a larger set of associated communications, and the communications in that set may be subsequently filtered based on more stringent criteria to arrive at a particular desired set of communications for a given original communication and set of criteria of interest. In some examples, communications collected may be identified using referencing identifications that may be used to access a set of communications of interest based on a set of criteria of interest.

At any time, a set of collected communications may be interacted with to gain useful insights, such as an overall impact of the original communication, where the most downstream communications was generated, an effect or ripple communication density over time after the original communication, and the like.

In some examples, the breadth of communications tracked may be specified by adjusting constraints and/or criteria on which communications may be contextually associated with a previous communication such that certain communications may be added to a set of communications associated with a particular original communication and/or ignored. For example, criteria may be set such that only explicitly related email messages (e.g., a direct email forward, a direct email reply, etc.) may be included in a set of associated communications. Any various constraints on context may be used. For example, constraints may specify that only contextually-related messages sent to an explicit list of team members may be associated with a particular original communication. The context similarity metric may be turned up or down, thereby changing membership in the set of communications. This may be implemented by reanalyzing communications related to an original communication using a revised context threshold.

The association of communications may be performed in any suitable manner. In some examples, a hidden image in a communication may be stored on a computing device managing the associations (e.g., a server). For example, a 1 pixel by 1 pixel transparent image may be included within a communication such that when the communication is opened by a recipient, the recipient's computing device may attempt to download the image from the server storing the image. The image's universal resource locator (URL) may be a unique path on the server, which may be tied directly to the communication, tying each access to the communication and thus monitoring how many people have viewed the communication. The recipient's internet protocol (IP) address and any other IP-derived data may be obtained when the recipient's computing device attempts to download the image from the server, and that data may be used to track the communication. This data may then be associated with a geographic location or with known registered computers (e.g., for a computer to get on a network, the computer must be registered to an owner who is then assigned an IP). Using a hidden image in a communication may allow the communication to be tracked without the recipient having to take any actions relating to tracking.

In some examples, a client-wrapper may be used to determine and manage associations between communications. For examples, a custom client or a plug-in for an existing client may be provided to communications for employees within a company to track communications that are received, opened, forwarded, replied to, and the like. The tracked information may be managed by a central server such that communications may be associated in any suitable manner and those associations may be used to generate a model specifying the associations.

In some examples, a customized communication standard may be used to track communications, including tracking a history of communications. History metadata may be stored in the header of a communication and may be transmitted back to the original source based on any suitable criteria (e.g., based on certain events occurring). In some examples, anyone who views the communication may view the history of the communication, or this ability to view the history may be based on permissions that may limit visibility of the history.

In some examples, communications may be tracked by asking a recipient of a communication to report the communication. For example, a hyperlink may be provided in a communication, and the recipient of the communication may be asked to click on the hyperlink and report information associated with the communication (e.g., whether the communication is forwarded and/or replied to, who the communication is forwarded to, downstream activity the recipient undertook as a result of receiving the communication, etc.).

In some examples, a company may set up a middleware service that may intercept communications before passing the communications to their respective recipient mail service (e.g., a proxy server). This may allow communications and/or traffic to be monitored and logged.

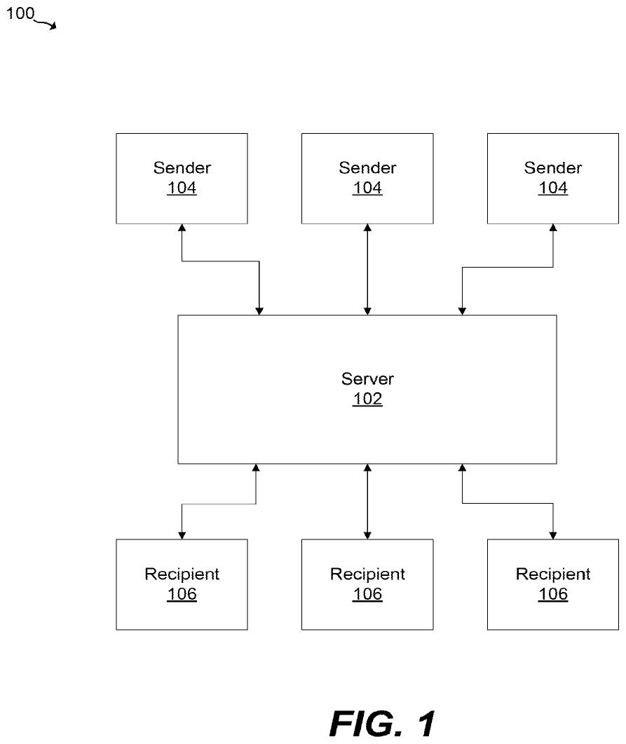

Referring now to the figures, FIG. 1 is a block diagram of an example system 100 for generating a model specifying an association between communications. System 100 may include server 102, which may be any suitable server, such as a web-based server, a local area network server, a cloud-based server, and the like. Server 102 may be any suitable server for accessing communications from any sender 104 to any recipient 106, analyzing the communications to obtain data associated with the communications (e.g., data associated with senders 104 and recipients 106 of each communication), creating associations between data from related communications (e.g., communications originating from the same communication), and generating a model specifying associations between communications. For example, server 102 may access a first and a second communication, where the second communication originates from the first communication. Server 102 may analyze the first communication to obtain first data associated with the first communication, where the first data includes data associated with a first sender (e.g., one of the senders 104) and a first recipient (e.g., one of the recipients 106) of the first communication. Server 102 may also analyze the second communication to obtain second data associated with the second communication, where the second data includes data associated with a second sender (e.g., one of the senders 104) and a second recipient (e.g., one of the recipients 106) of the second communication. Server 102 may create an association between the first data and the second data and may generate a model specifying the association based on the first data and the second data, where the model indicates an impact associated with the first communication and the second communication. The impact may be any effect associated with the communications. In some examples, server 102 may provide the model to any of the senders 104 and/or recipients 106. For example, a sender 104 may request information associated with a particular communication, and sever 102 may provide the related model to the sender 104. The model may be any suitable model (e.g., a network model based on clustering, a graph, a historic model, etc.) specifying information relating to an association between communications. For example, the model may specify senders, recipients, attachments, and/or contexts associated with the communications. As subsequent communications are sent, the model may be updated accordingly.

Server 102, senders 104, and recipients 106 may be in communication with each other directly or over a network, which may be any suitable network, such as an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks. Each sender 104 and each recipient 106 may be a computing device associated with a user that sends a communication via the computing device or receives a communication, respectively. For example, sender 104 may be a computing device through which a communication from a user is sent to another user, and recipient 106 may be a computing device through which a communication to a user is received from another user. Senders 104 may be capable of being a recipient of a communication, and recipients 106 may be capable of being a sender of a communication.

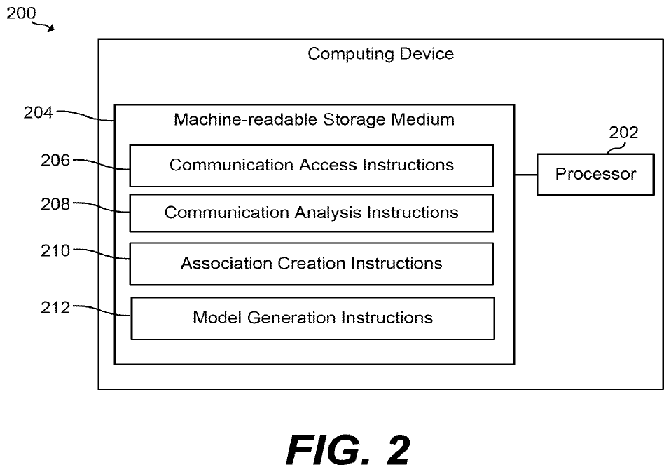

FIG. 2 is a block diagram of an example computing device 200 for generating a model specifying an association between communications. Computing device 200 may be a server (e.g., server 102 of FIG. 1) that may receive communications, identify data associated with the communications, and generate a model specifying associations between the communications based on the identified data.

Computing device 200 may be, for example, a web-based server, a local area network server, a cloud-based server, a notebook computer, a desktop computer, an all-in-one system, a tablet computing device, a mobile phone, an electronic book reader, a printing device, or any other electronic device suitable for generating a model specifying an association between communications. Computing device 200 may include a processor 202 and a machine-readable storage medium 204. Computing device 200 may receive a first communication and a second communication, identify data associated with those communications, store the data and an association between the data, and generate a model specifying the association.

Processor 202 is a tangible hardware component that may be a central processing unit (CPU), a semiconductor-based microprocessor, and/or other hardware devices suitable for retrieval and execution of instructions stored in machine-readable storage medium 204. Processor 202 may fetch, decode, and execute instructions 206, 208, 210, and 212 to control a process of generating a model specifying an association between communications. As an alternative or in addition to retrieving and executing instructions, processor 202 may include at least one electronic circuit that includes electronic components for performing the functionality of instructions 206, 208, 210, 212, or a combination thereof.

Machine-readable storage medium 204 may be any electronic, magnetic, optical, or other physical storage device that contains or stores executable instructions. Thus, machine-readable storage medium 204 may be, for example, Random Access Memory (RAM), an EPROM, an Electrically Erasable Programmable Read-Only Memory (EEPROM), a storage device, an optical disc, and the like. In some examples, machine-readable storage medium 204 may be a non-transitory storage medium, where the term “non-transitory” does not encompass transitory propagating signals. As described in detail below, machine-readable storage medium 204 may be encoded with a series of processor executable instructions 206, 208, 210, and 212 for receiving a first communication and a second communication, the second communication originating from the first communication; identifying first data associated with the first communication, the first data including data associated with a first sender and a first recipient; identifying second data associated with the second communication, the second data including data associated with a second sender and a second recipient of the second communication; storing the first data, the second data, and an association between the first data and the second data; and generating a model specifying the association based on the first data and the second data, the model indicating an impact associated with the first communication and the second communication.

Communication access instructions 206 may manage and control the receipt of and access to any communications (e.g., emails, text messages, documents, chat messages, tasks, etc.) to and/or from users associated with computing device 200. For example, communication access instructions 206 may receive and/or access communications that may be related (e.g., communications that originate from the same communication). Communication access instructions 206 may receive and/or access these communications in any suitable manner. For example, communications may be accessed based on a request to download an image in a particular communication, where the request may include information associated with the particular communication (e.g., sender and/or recipient information, IP address of the requester, etc.). In some examples, a client-wrapper associated with a communication may be used to access the communication.

Communication analysis instructions 208 may manage and control identification and analysis of data associated with communications. For example, communication analysis instructions 208 may identify any suitable data associated with related communications, such as sender information, recipient information, and the like.

Association creation instructions 210 may manage and control the creation of associations between related communications. For example, association creation instructions 210 may create an association between data from related communications and store the data as well as the associations. In some examples, the associations may be created using clustering of data from related communications.

Model generation instructions 212 may manage and control the generation of models specifying associations between related communications based on the data identified from those communications. For example, model generation instructions 212 may generate a model that may indicate the impact of a communication based on the association between that communication and other related communications.

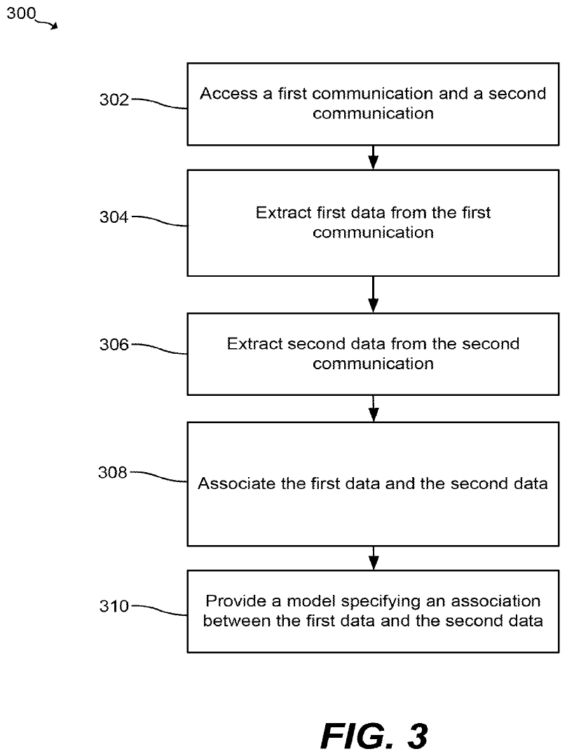

FIG. 3 is a flowchart of an example method 300 for providing a model specifying an association between communications. Method 300 may be implemented using computing device 200 of FIG. 2.

Method 300 includes, at 302, accessing a first communication and a second communication. The second communication may originate based on the first communication. For example, the second communication may be a communication that occurs in response to the first communication.

Method 300 also includes, at 304, extracting first data from the first communication. The first data may include any data associated with the first communication, such as data associated with a sender and/or a recipient of the first communication.

Method 300 also includes, at 306, extracting second data from the second communication. The second data may include any data associated with the second communication, such as data associated with a sender and/or a recipient of the second communication.

Method 300 also includes, at 308, associating the first data and the second data. The first data and the second data may be associated in any suitable manner, such as by storing the data together, associating the data with a common identifier, clustering the data together, and the like.

Method 300 also includes, at 310, providing a model specifying an association between the first data and the second data. The model may indicate an impact associated with the first communication and the second communication. For example, the model may specify individuals associated with the communications, the progression of communications, the context associated with the communications, and the like.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Non-transitory machine-readable media can be tangible and have machine-readable instructions stored thereon that are executable by a processor to implement examples according to the present disclosure.

An example system can include and/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable instructions. The machine-readable medium can include volatile and/or non-volatile memory such as a random access memory (“RAM”), magnetic memory such as a hard disk, floppy disk, and/or tape memory, a solid state drive (“SSD”), flash memory, phase change memory, and the like.

1. A computing device, comprising:
a processor to:
access a first communication comprising a first content associated with a first context and a second communication comprising a second content associated with a second context, the second communication originating based on the first communication;
analyze the first communication to obtain the first context and first data associated with the first communication, the first data including data associated with a first sender and a first recipient of the first communication, the first sender and the first recipient being employees of a company;
analyze the second communication to obtain the second context and second data associated with the second communication, the second data including data associated with a second sender and a second recipient of the second communication, the second sender and the second recipient being employees of the company;
determine whether the second context is related to the first context;
when the second context is related to the first context, create an association between the first data and the second data, wherein the association between the first data and the second data is created by clustering of the first data and the second data;
determine a set of employees of the company who have viewed at least one of the first and second communications based on the association and a hidden image within each of the first and second communications;
generate a network model based on the determined set of employees, the first data and the second data; and
provide a recommendation, to a first employee of the determined set of employees, to contact a second employee of the determined set of employees, based on the network model.

2. The computing device of claim 1, wherein the first communication or the second communication is an email, a text message, a document, a chat message, or a task.

3. The computing device of claim 1, wherein the network model specifies one or more of the first sender, the second sender, the first recipient, the second recipient, an attachment associated with the first communication, an attachment associated with the second communication, a context associated with the first communication, and a context associated with the second communication.

4. The computing device of claim 1, wherein the network model is a network model based on clustering, a graph, or a historic model.

5. The computing device of claim 1, wherein the processor is further to:
access a third communication, the third communication originating based on the first communication and the second communication; and
update the network model based on the third communication.

6. The computing device of claim 1, wherein the processor is further to:
receive a request to download the hidden image in the first communication, the request including information associated with the first communication, wherein the first communication is accessed based on the request; and
provide the hidden image in response to the request.

7. The computing device of claim 1, wherein the first communication is accessed using a client-wrapper associated with the first communication.

8. A method, comprising:
accessing, by a computing device, a first communication comprising a first content associated with a first context and a second communication comprising a second content associated with a second context, the second communication originating based on the first communication;
extracting, by the computing device, the first context and first data from the first communication, the first data including data associated with a first sender and a first recipient of the first communication, the first sender and the first recipient being employees of a company;
extracting, by the computing device, the second context and second data from the second communication, the second data including data associated with a second sender and a second recipient of the second communication, the second sender and the second recipient being employees of the company;
determining whether the second context is related to the first context;
when the second context is related to the first context, associating, by the computing device, the first data and the second data, the associating the first data and the second data comprising clustering of the first data and the second data;
determining a set of employees of the company who have viewed at least one of the first and second communications based on the association and a hidden image within each of the first and second communications;
providing, by the computing device, a network model based on the determined set of employees, the first data and the second data; and
providing a recommendation, to a first employee of the determined set of employees, to contact a second employee of the determined set of employees, based on the network model.

9. The method of claim 8, wherein the first communication or the second communication is an email, a text message, a document, a chat message, or a task.

10. The method of claim 8, wherein accessing the first communication comprises:
receiving, by the computing device, a request to download the hidden image in the first communication, the request including information associated with the first communication; and
providing, by the computing device, the hidden image in response to the request.

11. The method of claim 8, wherein accessing the first communication is based on a client-wrapper associated with the first communication.

12. A non-transitory machine-readable storage medium storing instructions that, if executed by at least one processor of a computing device, cause the computing device to:
receive a first communication comprising a first content associated with a first context and a second communication comprising a second content associated with a second context, the second communication originating based on the first communication;
identify the first context and first data associated with the first communication, the first data including data associated with a first sender and a first recipient of the first communication, the first sender and the first recipient being employees of a company;
identify the second context and second data associated with the second communication, the second data including data associated with a second sender and a second recipient of the second communication, the second sender and the second recipient being employees of the company;
determine whether the second context is related to the first context;
when the second context is related to the first context, store the first data, the second data, and an association between the first data and the second data, wherein the association between the first data and the second data is created by clustering of the first data and the second data;
determine a set of employees of the company who have viewed at least one of the first and second communications based on the association and a hidden image within each of the first and second communications;
generate a network model based on the determined set of employees, the first data and the second data; and
provide a recommendation, to a first employee of the determined set of employees, to contact a second employee of the determined set of employees, based on the network model.

13. The non-transitory machine-readable storage medium of claim 12, wherein the first communication or the second communication is an email, a text message, a document, a chat message, or a task.

14. The non-transitory machine-readable storage medium of claim 12, wherein the network model specifies one or more of the first sender, the second sender, the first recipient, the second recipient, an attachment associated with the first communication, an attachment associated with the second communication, a context associated with the first communication, and a context associated with the second communication.

15. The non-transitory machine-readable storage medium of claim 12, wherein the instructions further cause the computing device to:
access a third communication, the third communication originating based on the first communication and the second communication; and
determine whether to update the network model based on the third communication, wherein determining whether to update the model is based on specified criteria applied to the third communication.
